(19) United States
(12) Patent Application Publication
(10) Pub. No.: US 2007/0201842 A1
(43) Pub. Date: Aug. 30, 2007

(54) Switched Dc Electrical Machine

(76) Inventor: Dennis Charles Earnshaw, Collie (AU)

Correspondence Address: GARDNER GROFF SANTOS & GREENWALD, P.C., 2018 POWERS FERRY ROAD, SUITE 800, ATLANTA, GA, 30339, US

(21) Appl. No.: 10/581,677

(22) PCT Filed: Dec. 3, 2004
(86) PCT No.: PCT/AU04/01643

§ 371 Date: Feb. 28, 2007

(30) Foreign Application Priority Data
Dec. 5, 2003 (AU) 2003906717

(51) Int. Cl. H02P 5/00

(52) U.S. Cl. 388/800

(57) ABSTRACT

A switched DC rotating electrical machine (100) comprising a stator (3), a rotor (2) and switching means (11a, 11b, 18a, 18b), an excitation winding (5) associated with one of the stator (3) or the rotor (2) having a pair of inputs, the excitation winding (5) being adapted to cause magnetization of a plurality of magnetic poles (4a -4l), the switching means (11a, 11b, 18a, 18b) being adapted to be associated with a DC voltage source (19) to switch the output thereof to the first and a second input of the excitation winding (5), the DC voltage source (19) providing a low voltage output (−V), an intermediate voltage output (0V) and a high voltage output (+V), wherein in use the intermediate voltage output is continuously connected to the first input of said excitation winding 19 and the second input is switched in a cyclic operation by the switching means between connection with the high voltage output (+V) and the low voltage output (−V).

### FIELD OF THE INVENTION

The present invention relates to rotating electrical machines. In particular it discloses a new way of arranging and operating an electric motor or generator.

### BACKGROUND ART

Electric motors have been in wide use for more than 100 years. In general, such motors are classified as AC (alternating current) or DC (direct current) according to the type of current drawn to power them. Within each type a variety of sub-classifications exist and a wide number of configurations have been tried to obtain particular performance characteristics.

The advent of high-current solid-state devices such as diodes and thyristors or SCRs has enabled significant changes from conventional designs in both AC and DC motors, allowing important improvements to be obtained for various applications. In the area of DC motors, such devices, coupled with accurate positional sensing devices have enabled motors to be designed without the use of the commutators, thereby significantly reducing maintenance requirements of such motors. The disclosures of Wilkinson (U.S. Pat. No. 3,025,443) and Fausto Guastadini in U.S. Pat. No. 4,678,974 and WO 86/06564 are examples of only a few of such designs. Nevertheless, such devices have relied on the maintenance of magnetic fields according to conventional models for their design.

The preceding discussion of the background to the invention is intended only to facilitate an understanding of the present invention. It should be appreciated that the discussion is not an acknowledgement or admission that any of the material referred to was part of the common general knowledge in Australia as at the priority date of the application.

### DISCLOSURE OF THE INVENTION

Accordingly, the invention resides in a switched DC rotating electrical machine comprising a stator, a rotor and switching means, one of said stator and rotor comprising an excitation winding having a first and a second input, the excitation winding being adapted when energized to cause magnetization of a plurality of poles associated with said excitation winding, the switching means being adapted to be associated with a DC voltage source to switch the output thereof to the first and a second input of the excitation winding, the DC voltage source providing a low voltage output, a high voltage output and an intermediate voltage output having an electrical potential intermediate the electrical potentials of the high voltage output and the low voltage output, wherein in use the intermediate voltage output is continuously connected to the first input of said excitation winding and the second input is switched in a cyclic operation by said switching means between connection with the high voltage output and the low voltage output.

According to a preferred feature of the invention, the cycle of the cyclic operation also including segments of time when the second input is disconnected from either of said low voltage or high voltage outputs.

According to a preferred feature of the invention, the excitation winding is configured to energize adjacent poles associated with said excitation winding with opposite magnetic polarity.

According to a preferred feature of the invention, the voltage differential between the low voltage output and the intermediate voltage output is substantially the same as the voltage differential between the intermediate voltage output and the high voltage output.

According to a preferred feature of the invention, wherein the other of said stator and rotor not comprising said excitation winding comprises an even plurality of poles.

According to a preferred feature of the invention, the second input is switched to the high voltage output or the low voltage output when a pole of the rotor is positioned in opposed relationship to a pole of the stator.

According to a preferred feature of the invention, the second input is switched to a disconnected state substantially at a predetermined moment selected to minimize transient currents.

According to a preferred feature of the invention, the second input is disconnected from the DC voltage source for a substantial proportion of the cyclic period.

According to a preferred feature of the invention, the switching of the switching means is synchronised with the rotation of the rotor.

According to a preferred feature of the invention, the switching means comprises sensing means adapted to cause switching of the switching means according to the rotational position of the rotor.

According to a preferred embodiment, the sensing means comprises a photoelectric sensor.

According to a preferred embodiment, a timing wheel is associated with the sensing means to provide a reference for the rotational position of the rotor.

Accordingly to a further aspect, the invention resides in a switched DC rotating electrical machine comprising a stator, a rotor and switching means, the stator being configured with a stator set of poles comprising a plurality of magnetic poles and the rotor being configured with a rotor set of poles comprising a plurality of magnetic poles, a one set of said stator set and rotor set being configured to provide a magnetic field and the other set of said stator set and rotor sets being configured with an excitation coil associated with each pole of said other set, said coils being adapted to be excited by a DC voltage source to thereby induce a magnetic field in association with each pole, said coils being configured to cause said magnetic fields of adjacent poles to be of opposite polarity, connection to said DC voltage source being controlled by said switching means whereby in use, by the rotation of the rotor with respect to the stator, the magnetic field of the one set is adapted to move relative to the poles of the other set, the DC voltage source having a low voltage output, a high voltage output and an intermediate voltage output, intermediate voltage output being adapted in use to be continuously connected to a first input of the said coils and the second input being adapted to be cyclically switched by said switching means between said low voltage output and said high voltage output.

Accordingly to a further aspect, the invention resides in a switched DC rotating electrical machine comprising a stator, a rotor and switching means, one of said stator and rotor comprising an excitation winding having a first and a second input, the excitation winding being adapted when energized to cause magnetization of a first even plurality of poles associated with said excitation winding and being configured to energize adjacent said poles associated with opposite magnetic polarity, the other of said stator and rotor comprising a second even plurality of poles, the switching means being adapted to be associated with a DC voltage source to switch the output thereof to a first and a second input of the excitation winding in cyclic operation, the switching means being configured to cause switching of the excitation winding to an energized state when a pole of the rotor is positioned in opposed relationship to a pole of the stator.

According to a preferred embodiment, the electrical machine is an electric motor. According to a preferred embodiment, the excitation coil is associated with the stator. According to a preferred embodiment, the rotor comprises a permanent magnet.

According to a preferred embodiment, the electrical machine is an electric generator.

The invention will be more full understood in light of the following description of one specific embodiment.

### BRIEF DESCRIPTION OF THE DRAWINGS

The description is made with reference to the accompanying drawings of which:

FIG. 1 is a rear isometric view of a stator, rotor and switching means of a switched DC electric motor in accordance with first embodiment;

FIG. 2 is a front isometric view of a stator, rotor and switching means of the switched DC electric motor shown in FIG. 1;

FIG. 3 is an isometric view of the rotor of the switched DC electric motor of FIG. 1 in position A;

FIG. 4 is a front view of the rotor shown in FIG. 3 in position A;

FIG. 5 is a front view of the switched DC electric motor shown in FIG. 1 showing the timing wheel in a first position (position A);

FIG. 6 is a front view of the switched DC electric motor shown in FIG. 1 showing the timing wheel in a second position (position B);

FIG. 7 is a front view of the switched DC electric motor shown in FIG. 1 showing the timing wheel in a third position (position C);

FIG. 8 is a front view of the switched DC electric motor shown in FIG. 1 showing the timing wheel in a fourth position (position D);

FIG. 9 is a perspective view of the stator assembly of the switched DC electric motor shown in FIG. 1;

FIG. 10 is a front view of the stator assembly of the switched DC electric motor shown in FIG. 1;

FIG. 11 depicts a diagrammatic arrangement of the circuit of the embodiment; and

FIG. 12 depicts the timing of connection of the second input of the stator winding of the embodiment to the DC voltage source via the switching means.

### DETAILED DESCRIPTION OF PREFERRED EMBODIMENTS

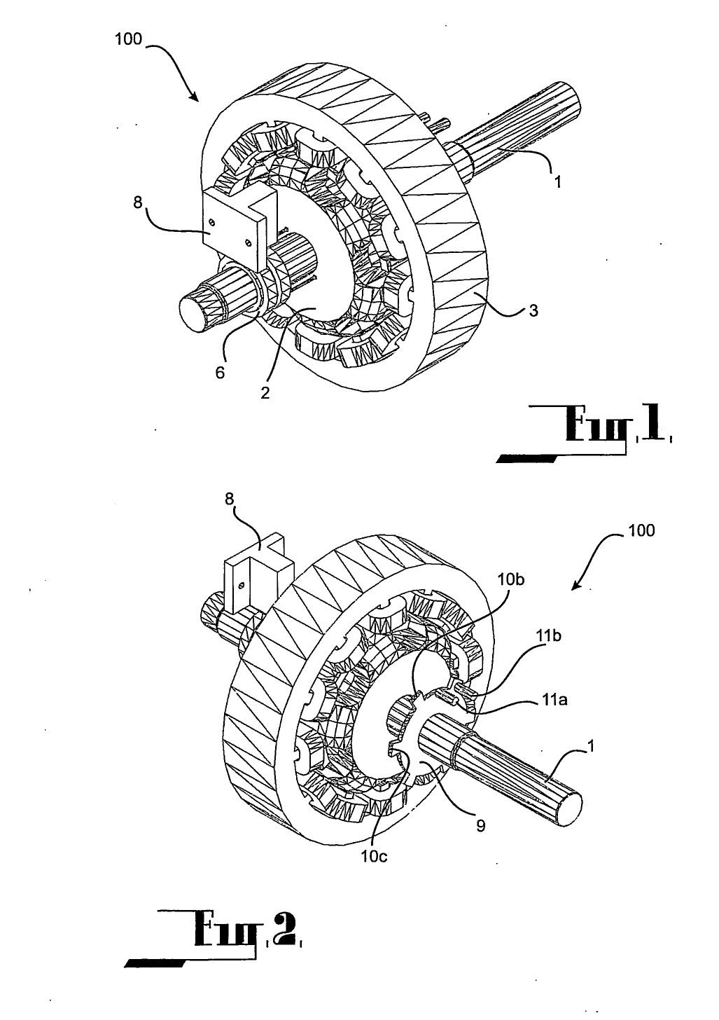

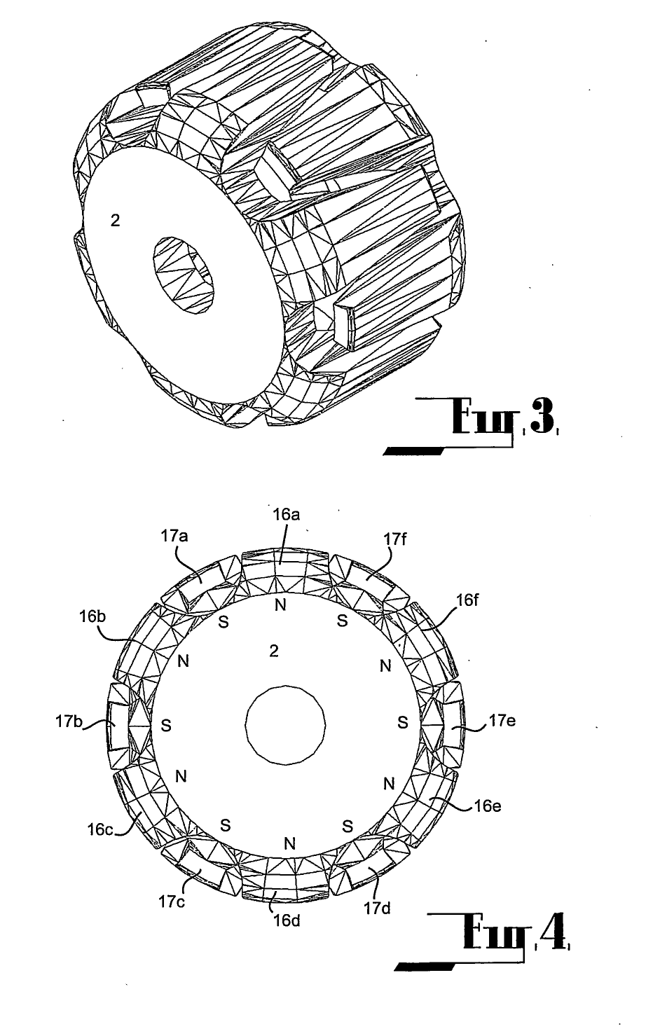

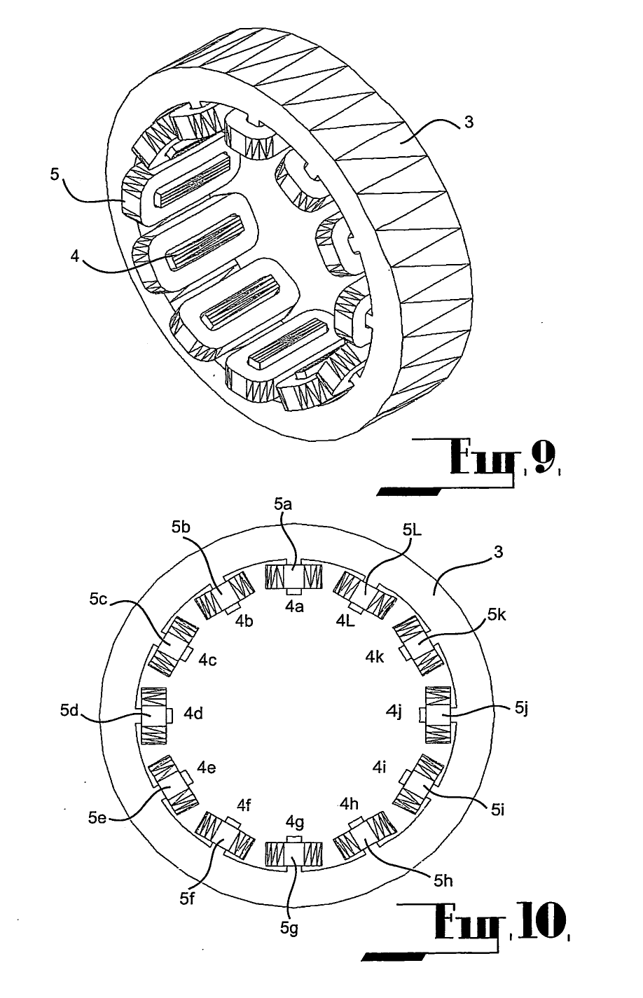

The embodiment of the invention comprises a rotating electrical machine in the form of an electrical motor controlled by switching means. The embodiment is described with reference to FIGS. 1 to 12.

As shown in the drawings, the electrical motor 100 of the embodiment comprises a stator assembly 3, a brush assembly 8, and a shaft 1 supporting a rotor assembly 2, slip rings 6a and 6b, a timing wheel 9 and switching devices 18a and 18b.

The stator assembly 3 comprises a set of stator poles 4a, 4b, 4c, 4d, 4e, 4f, 4g, 4h, 4i, 4j, 4k, 4l and stator coils 5a, 5b, 5c, 5d, 5e, 5f, 5g, 5h, 51, 5j, 5k, 5l. Stator coils 5a, 5c, 5e, 5g, 5i, 5k, have their windings configured to provide an excitation current in a clockwise direction, and stator coils 5b, 5d, 5f, 5h, 5j, 5l, have their windings configured to provide an excitation current in an anti-clockwise direction so that adjacent poles have opposite magnetic polarity. The stator coils may be connected in circuit to each other either in “parallel” or in “series” to provide the stator excitation winding 5 so that a two wire input is required to energize all of the stator coils.

The rotor assembly 2 comprises a first set of “fixed” magnetic poles 16a, 16b, 16c, 16d, 16e, 16f, and second set of “fixed” magnetic poles 17a, 17b, 17c, 17d, 17e, 17f of opposite polarity, energized by a suitable rotor winding 4 to provide a magnetic field. The timing wheel 9 is provided with a plurality of timing tags 10a, 10b, 10c, 10d, 10e, 10f matching the number of pole pairs of the rotor. The timing wheel is fixed to the shaft to be rotatable with the shaft.

The brush assembly 8 comprises a pair of brushes (not shown) adapted to bear on the slip rings and convey energizing current to the rotor coils from a suitable rotor power supply 21. In the embodiment, the rotor power supply 21 provides DC power and it will be appreciated that in operation, the magnetization will be of constant polarity, although it is possible to change the strength according to the strength of the magnetizing current. The brush assembly 8 and photo electric sensors 11a and 11b are supported from the motor housing (not shown) or alternatively from the stator assembly.

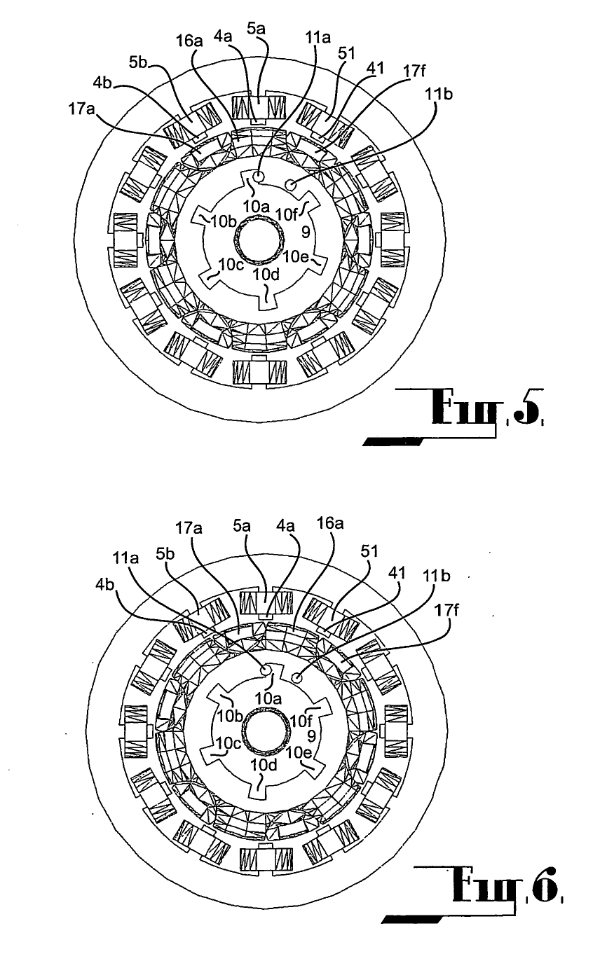

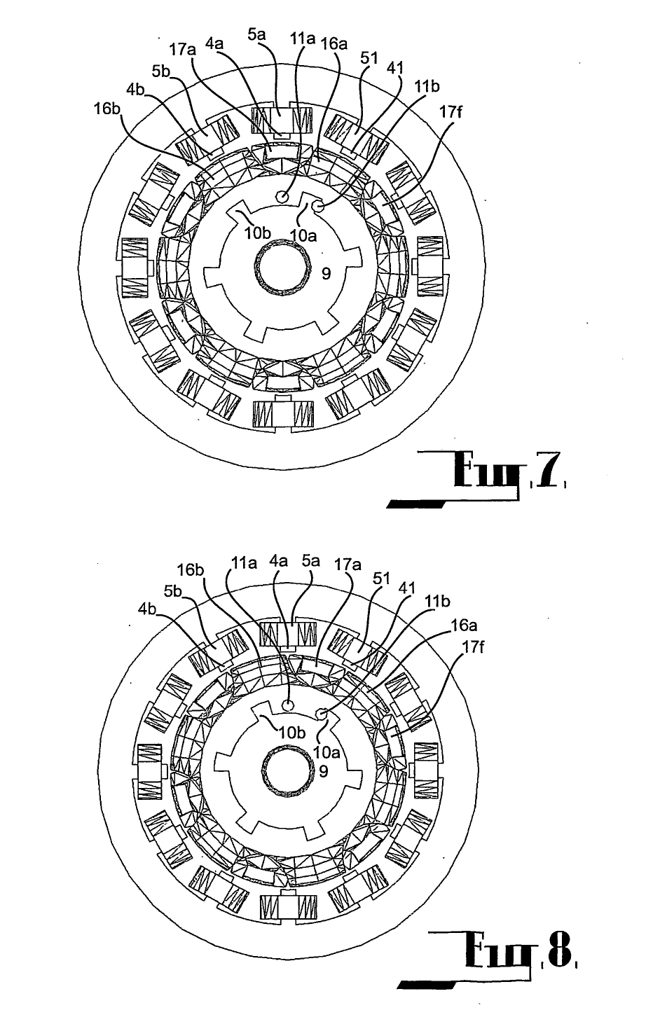

The switching means comprises the photo electric sensors 11a and 11b mounted to cooperate with the timing wheel 9 and being connectable to electronic switching devices 18a and 18b to trigger switching devices 18a and 18b in a predetermined manner. The photo electric sensors 11a and 11b are positioned to cooperate with the timing tags of the timing wheel 9. The photoelectric sensors 11a, 11b are energized by a suitable power source. When the timing wheel is rotated, to the position shown in FIG. 5, light from the photoelectric sensor 11a is reflected back to 11a from timing wheel tag 10a, closing the internal circuit of photoelectric sensor 11a, sending a signal to an electronic switch set 18a. When the timing wheel is rotated to the position shown in FIG. 6, light from the photoelectric sensor 11a is no longer reflected back to 11a from timing wheel tag 10a, so that the internal circuit of photoelectric sensor 11a opens, ending the signal to an electronic switch set 18a. Likewise, when the timing wheel is rotated to the position shown in FIG. 7, light from the photoelectric sensor 11b is reflected back to 11b from timing wheel tag 10a, closing the internal circuit of photoelectric sensor 11b, sending a signal to an electronic switch set 18b. When the timing wheel is rotated to the position shown in FIG. 8, light from the photoelectric sensor 11b is no longer reflected back to 11b from timing wheel tag 10a, so that the internal circuit of photoelectric sensor 11b opens, ending the signal to an electronic switch set 18b.

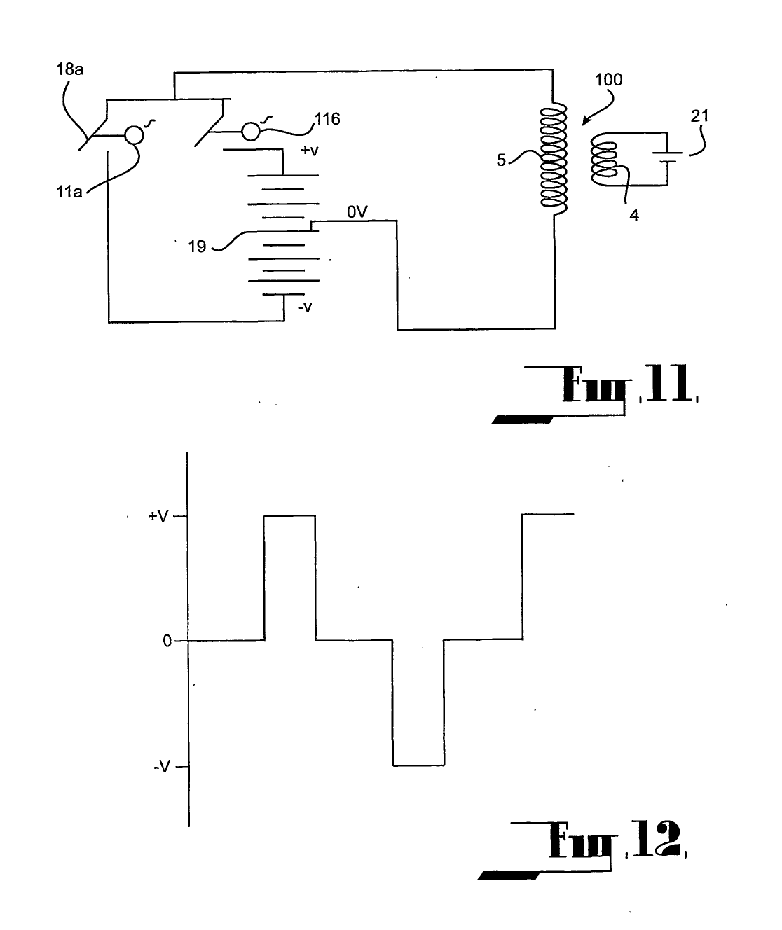

As shown in FIG. 11, the stator excitation winding 5 of the electrical motor 100 is adapted to be connected to a DC power source 19 having output switched by high speed electronic switching devices 18a and 18b triggered by the photo electric sensors 11a and 11b. The embodiment requires a power source having three voltage levels, whereby an intermediate voltage is connected continuously to a first connection of the excitation winding 5. The DC power source 19 provides a 3-wire supply providing voltages of +V, 0V and −V respectively where the value of the voltage between the 0V and +V outputs is substantially the same as from −V to 0V. In use, the 0V wire is continuously connected to a first connection of the two-wire input to the stator coils. The second connection of the two-wire input to the stator coils is adapted in use to be switched by switching devices 18a and 18b between the outputs +V, disconnected, −V, disconnected and +V in cyclic manner as described in more detail below. Thus it can be seen that the second input has relatively substantial periods between each of the voltage pulses when it is disconnected from either of the high or low voltages.

Such a voltage source might be provided in a range of ways including a battery of cells, with a takeoff from an intermediate cell providing the intermediate voltage.

It will be seen that switch set 18a is wired to deliver dc current from power source 19, through stator coils, 5a-5l in the forward direction, while switch set 18b, is wired to deliver dc current from power source 19 through stator coils 5a-5l, in the reverse direction.

Direct current from power source 19 is also fed via an appropriate circuit through the photoelectric sensors 11a and 11b, and then (at the correct timing) to the electronic switch sets 18a or 18b, to turn them on and off, powering stator coils 5a-51. In the embodiment as described, the stator assembly is provided with twelve stator poles 4a-4l and the rotor assembly is provided with twelve rotor poles 16a-16f and 17a-17f. In operation, six cycles are performed by the stator coils 5a-5l, each revolution of the shaft 1 and rotor assembly 2. Each cycle then is made up of four parts, they being:
(A.) Direct current from power source 19 is fed through switch set 18a to stator coils 5a-5l in the forward direction, magnetizing stator poles 4a-4l (FIG. 5).
(B.) Direct current from power source 19 fed through switch set 18a to stator coils 5a -5l is turned off, allowing the magnetization of stator poles 4a -4l to decay (FIG. 6).
(C.) Direct current from power source 19 is fed through switch set 18b to stator coils 5a -5l in the reverse direction, magnetizing stator poles 4a -4l in the opposite direction of polarity (FIG. 7).
(D.) Direct current from power source 19 fed through switch set 18b to stator coils 5a -5l is turned off, allowing the magnetization of stator poles 4a -4l to decay (FIG. 8).

This cycle of the switching signal sent by the photo-electric sensors 11a and 11b to the solid state switches 18a and 18b to switch the second input to the DC voltage source 19 is represented by the graph shown in FIG. 12.

During one complete cycle, the voltage across the stator coils 5a -51, rises from 0 volts to +V volts, almost instantaneously, is held at +V volts for a predetermined period at which time the switching means disconnects the second input, the voltage then falls back to substantially to 0 volts, then is switched almost instantaneously to −V volts, is held at −V volts for a second predetermined period being substantially of the same duration as said first predetermined period, at which time the switching means again disconnects the second input and the voltage then rises to substantially 0 volts.

The switching to a high or low voltage should occur as closely as possible to the moment when poles of the rotor are in directly opposed relationship to corresponding poles of the stator. This is necessary so that the electron current flow in the excitation winding 5 immediately after switching is minimized. Testing has shown that the efficiency of the device is affected by the precision and speed with which the switching can be made to occur.

The disconnection of the second connection from the high or low voltage should also occur as closely as possible to a precise moment during the cyclic period. This moment appears to be a characteristic of the configuration of the motor and the parameters which determine it and the reasons for it are not fully understood at this time. However, deviations of switching from this optimal moment will cause significant current transients which can be sufficient to destroy the switching devices in some configurations. In tests, a motor according to the embodiment required to be disconnected approximately 30% of the cyclic period between pulses of connection to either of the high or low voltage outputs.

The operation of the switched DC electric motor of the embodiment may be better understood by further reference to FIGS. 5 to 8. In operation, the rotor coils are energized so that rotor poles 16a -16f are energized north, while rotor poles 17a-17f are energized south (FIG. 4). This polarity is not reversed during operation.

At position A (FIG. 5) stator poles 4a -41, having their coils energized, begin to oppose the rotor poles 16a -16f and 17a -17f, and induces rotor 2 to move in a clockwise direction. When rotor 2 reaches position B (FIG. 6) current from photoelectric sensor 11a is turned off, circuits to electronic switch set 18a, and to stator coils 5a -51 are opened and current flow from dc power source 19 through them ceases. Back emf then continues to energize stator coils 5a -5l, until their voltage drops to 0 volts. Rotor poles 17a -17f, 16a -16f, meanwhile are attracted to the stator poles 4a -4l inducing the rotor 2 to continue in it's clockwise direction between position B (FIG. 6) and position C (FIG. 7).

Upon the rotor 2 and timing wheel tab 10a reaching position C, (FIG. 7) the timing photoelectric sensor 11b, is turned on. Current from dc power source 19 flows to electronic switch set 18b closing its internal circuit to enable current from the dc power source 19 to flow through the stator coils 5a -5l in the reverse direction charging them to −V volts and inducing a reverse order of polarity within stator poles 4a -4l. Rotor poles 17a -17f, 16a -16f, now being opposed by stators 4a -4l, continue to move in a clockwise direction away from the opposing stator poles 4a -4l.

When rotor 2 reaches position D (FIG. 8) current from photoelectric sensor 11a is turned off, circuits to electronic switch set 18b, and to stator coils 5a -5l are opened and current flow from dc power source 19 through them ceases. Back emf then continues to energize stator coils 5a -5l, until their voltage rises to 0 volts. Rotor poles 16a -16f, 17a -17f, meanwhile are attracted to the stator poles 4a -4l inducing the rotor 2 to continue in it's clockwise direction between position D (FIG. 8) and position E, where the cycle repeats itself.

It should be noted that the rotor power supply mentioned above may be independent from the DC power source 19 used to provide electric power to the stator winding, as shown in FIG. 11 or alternatively power may be taken from the DC power source 19 to excite the rotor.

It should also be noted that the embodiment comprises an equal number of poles on the rotor as is present on the stator. The actual number on each may differ from the number used in the embodiment described, but must be even to provide an equal number of north and south magnetised poles. It is understood that the number of poles selected will be one of the factors contributing to the performance characteristics of a particular design. It is believed that it would be possible for the rotor of the embodiment to be configured with a number of poles which is different to the number on the stator, although it is expected that some complications may result.

Those skilled in the art will recognize that the design of the embodiment may be adapted in many ways while still incorporating the essential features of the invention. For instance, the number of pole pairs in the stator and rotor may be changed from the embodiment. Also a rotor having an excitation coil may be replaced with a permanent magnet. In that event, the need for slip rings to the rotor will be avoided. Many alternative switching means are possible instead of the photo-electric sensors and timing wheel arrangement described above. For example, magnetic or Hall-effect sensors may replace the photo-electric sensors. More basically, the switched DC power source could be applied to the rotor rather than to the stator without changing the fundamental theory of operation of the machine. Likewise, at a fundamental level, those skilled will know that the theories used to produce a motor can be adapted in reverse to provide an electrical generator. Thus the embodiment described can readily be adapted as a generator. It is to be appreciated that all such variations are to be considered within the scope of the invention.

Testing of an electric motor according to the embodiment has shown the motor to have a high coefficient of performance. It has also been found that motor runs cooler than a comparable motor of conventional design.

Throughout the specification, unless the context requires otherwise, the word “comprise” or variations such as “comprises” or “comprising”, will be understood to imply the inclusion of a stated integer or group of integers but not the exclusion of any other integer or group of integers.

1. A switched DC rotating electrical machine comprising a stator, a rotor and switching means, one of said stator and rotor comprising an excitation winding having a first and a second input, the excitation winding being adapted when energized to cause magnetization of an even plurality of poles associated with said excitation winding, the switching means being, in use, associated with a DC voltage source, the DC voltage source providing a low voltage output, a high voltage output and an intermediate voltage output having an electrical potential intermediate the electrical potentials of the high voltage output and the low voltage output, wherein in use the intermediate voltage output is continuously connected to the first input and the second input is switched in a cyclic operation by said switching means between connection with the high voltage output and the low voltage output and wherein the cycle of the cyclic operation also includes segments of time when the second input is disconnected from either of said low voltage or high voltage outputs.

2. (canceled)

3. An electrical machine as claimed at claim 1 wherein the excitation winding is configured to energize adjacent poles associated with said excitation winding with opposite magnetic polarity.

4. An electrical machine as claimed at claim 1 wherein the voltage differential between the low voltage output and the intermediate voltage output is substantially the same as the voltage differential between the intermediate voltage output and the high voltage output.

5. An electrical machine as claimed at claim 1 wherein the other of said stator and rotor not comprising said excitation winding comprises an even plurality of poles.

6. An electrical machine as claimed at claim 1 wherein the switching of the switching means is synchronised with the rotation of the rotor.

7. An electrical machine as claimed at claim 6 wherein switching means comprises sensing means adapted to cause switching of the switching means according to the rotational position of the rotor.

8. An electrical machine as claimed at claim 7 wherein the sensing means comprises a photoelectric sensor.

9. An electrical machine as claimed at claim 7 a timing wheel is associated with the sensing means to provide a reference for the rotational position of the rotor.

10. An electrical machine as claimed at claim 6 wherein the second input is switched to the high voltage output or to the low voltage output when a pole of the rotor is positioned in opposed relationship to a pole of the stator.

11. An electrical machine as claimed at claim 6 wherein the second input is switched to a disconnected state substantially at a predetermined moment selected to minimize transient currents.

12. An electrical machine as claimed at claim 11 wherein the second input is disconnected from the DC voltage source for a substantial proportion of the cyclic period.

13. A switched DC rotating electrical machine comprising a stator, a rotor and switching means, the stator being configured with a stator set of poles comprising a plurality of magnetic poles and the rotor being configured with a rotor set of poles comprising a plurality of magnetic poles, a one set of said stator set and rotor set being configured to provide a magnetic field and the other set of said stator set and rotor set being configured with an excitation coil associated with each pole of said other set, said coils being adapted to be excited by a DC voltage source by means of a first input and a second input to thereby induce a magnetic field in association with each pole, said coils being configured to cause said magnetic fields of adjacent poles to be magnetized to opposite polarity, connection to said DC voltage source being controlled by said switching means whereby in use, by the rotation of the rotor with respect to the stator, the magnetic field of the one set is adapted to move relative to the poles of the other set, the DC voltage source having a low voltage output, a high voltage output and an intermediate voltage output having an electrical potential intermediate the electrical potentials of the high voltage output and the low voltage output, the intermediate voltage output being in use, continuously connected to the first input and the second input being adapted to be cyclically switched by said switching means between said low voltage output and said high voltage output and wherein the cycle of the cyclic operation also includes segments of time when the second input is disconnected from either of said low voltage or high voltage outputs.

14. A switched DC rotating electrical machine comprising a stator, a rotor and switching means, one of said stator and rotor comprising an excitation winding having a first and a second input, the excitation winding being adapted when energized to cause magnetization of a first even plurality of poles associated with said excitation winding and being configured to energize poles adjacent said associated poles with opposite magnetic polarity, the other of said stator and rotor comprising a second even plurality of poles, the switching means being associated with a DC voltage source having a low voltage output, a high voltage output and an intermediate voltage output having an electrical potential intermediate the electrical potentials of the high voltage output and the low voltage output, wherein, in use, the intermediate voltage output is continuously connected to the first input of said excitation winding and the second input is switched in said cyclic operation by said switching means between connection with the high voltage output and the low voltage output, the switching means being configured to cause switching of the excitation winding to an energized state when a pole of the rotor is positioned in opposed relationship to a pole of the stator and wherein the cycle of the cyclic operation also includes segments of time when the second input is switched to a state disconnected from the DC voltage source.

15. (canceled)

16. An electrical machine as claimed at claim 14 wherein the second input is switched to said disconnected state substantially at a predetermined moment selected to minimize transient currents.

17. An electrical machine as claimed at claim 16 wherein the switching of the switching means is synchronised with the rotation of the rotor.

18. An electrical machine as claimed at claim 17 wherein switching means comprises sensing means adapted to cause switching of the switching means according to the rotational position of the rotor.

19. An electrical machine as claimed at claim 18 wherein the sensing means comprises a photoelectric sensor.

20. An electrical machine as claimed at claim 18 wherein a timing wheel is associated with the sensing means to provide a reference for the rotational position of the rotor.

21. (canceled)

22. An electrical machine as claimed at claim 14 wherein the electrical machine is an electric motor.

23. An electrical machine as claimed at claim 14 wherein the electrical machine is an electric generator.

24. An electrical machine as claimed at claim 14 wherein the excitation winding is associated with the stator.

25. An electrical machine as claimed at claim 24 wherein the rotor comprises a winding energized from a DC power supply via slip rings.

26. An electrical machine as claimed at claim 24 wherein the rotor comprises a permanent magnet.
